(19) United States
(12) Patent Application Publication
(10) Pub. No.: US 2008/0263338 A1
(43) Pub. Date: Oct. 23, 2008

(54) EXCEPTION OPERATION APPARATUS, METHOD AND COMPUTER PROGRAM FOR CONTROLLING DEBUGGING APPARATUS, AND TELEVISION AND CELLULAR PHONE PROVIDING THE SAME

(76) Inventors: Takuya Ohkubo, Narashino-shi (JP); Keiji Fukumoto, Chiba-shi (JP)

Correspondence Address: BIRCH STEWART KOLASCH & BIRCH, PO BOX 747, FALLS CHURCH, VA, 22040-0747, US

(21) Appl. No.: 12/062,397

(22) Filed: Apr. 3, 2008

(30) Foreign Application Priority Data
Apr. 4, 2007 (JP) 2007-098290

(51) Int. Cl. G06F 9/30

(52) U.S. Cl. 712/227; 712/E09.032

(57) ABSTRACT

In order to automatically activate a debugger while maintaining the status of the machine as it was just before execution of the instruction which has raised an exception even in a case in which a break point is not set beforehand, a computer, which executes a program to be debugged, analyzes an exception raised on the computer, and replaces an instruction with another instruction for activating a debugger if the exception has been raised due to the instruction that conducts an abnormal operation and is stored in a memory space. After this, the computer selects and switches to a task to be processed based on the status of each of the tasks, or resumes an operation which has been suspended due to the exception. Then, when the computer executes the instruction for activating the debugger, the debugger detects this execution and is activated.

### BACKGROUND OF THE INVENTION

1. Field of the Invention

The present invention relates to an exception operation apparatus, method and computer program. In particular, the present invention relates to an exception operation apparatus, method and computer program for controlling a debugging apparatus of a computer system.

Priority is claimed on Japanese Patent Application No. 2007-98290, filed Apr. 4, 2007, the content of which is incorporated herein by reference.

2. Description of the Related Art

First, technical terms used below are explained, and after that, a conventional debugging operation is explained.

Here, a “debugger” is an apparatus for supporting an operation of modifying or repairing a computer program (hereinafter referred to as a debugging operation). In general, in order to analyze the execution status of a computer program in detail upon actually executing the computer program by a central processing unit (hereinafter referred to as a CPU), such a debugger provides functions of, for example, temporally suspending an operation of the CPU, supporting checking operations of an internal status of the CPU, and controlling the CPU so as to incrementally execute the instructions of the computer program. A programmer observes or checks an operation of the CPU by using such functions and analyzes the computer program in order to find a portion of the computer program that works in a different manner from what the programmer has expected, and after that, the programmer tries to obtain a tip or hint for finding the problematic code of the computer program.

Here, an example of the constitution of an apparatus is used for debugging. Via a probe (touching a device under test), a debugger is connected to a CPU of a computer on which a computer program to be debugged is to be executed. In addition, the debugger is connected to a generally used personal computer via a communication interface, and a debugger control program executed on the personal computer controls the debugger. It should be noted that FIGS. 10 and 11 explained below show examples of personal computer screens controlled by a conventional debugger control program. An operator inputs commands by, for example, pushing keys in order to operate the debugger, and the personal computer displays the status of the CPU, memory, and the like of the computer on which the computer program to be debugged is executed. It should be noted that the personal computer is not shown in the drawings which explain embodiments described below.

It should be noted that the debugger can be built for execution on the computer on which the computer program that is debugged is executed.

An operation of temporally suspending the processing of the CPU by the debugger in order to obtain an analyzable status of the CPU and the like is called “activation” of the debugger. There are two methods to activate the debugger. In a first method, the debugger is activated in accordance with a command inputted by the operator, and in a second method, the CPU executes a specific instruction that activates the debugger (“debugger activation instruction”). When the CPU executes such a debugger activation instruction, the debugger automatically detects the instruction and starts operation of the debugger. One of such instructions is a “break instruction” described below. If the debugger is activated, the debugger, for example, displays a screen urging the operator to start a debugging operation.

A “multitasking computer system” is a computer system which has a constitution that can execute multiple computer programs in parallel due to the function of “task switching” described below.

A “task” is a unit for managing a program, data, status of the CPU while processing, and the like. When the CPU detects an “exception” described below, the CPU temporally suspends execution of the computer program which has raised the exception and stores the status of the corresponding task (the program, data and status of the CPU corresponding to the task). In addition, in place of the suspended computer program, the CPU can recover the status of another task which has been suspended before detecting the exception and resume the task, or newly create and start a task which is different from the suspended task. Such an operation is called “task switching”, and the task which is resumed (started) in this operation is called an “executing” task. An “execution of multiple compute programs in parallel” of the above-described multitasking computer system is a technique in which the above-described “task switching” is periodically and so rapidly repeated, and consequently carries out almost the same function as simultaneously executing multiple programs on the multiple CPU.

Here, a “memory space” is a logical memory apparatus provided by a virtual memory technique of a CPU. With regard to the virtual memory technique, information is divided and stored in an external storage device such as a hard disk and a physical memory apparatus, and the stored information arranged in the external storage device and the physical memory apparatus are swapped if necessary. Consequently, the virtual memory technique can perform as if a memory apparatus larger than the actual physical memory apparatus is provided by the computer system. In addition, in the multitasking computer system, by applying the above-described virtual memory technique, information stored in the memory space is completely swapped at the exact time that the task switching operation is conducted, and consequently, it is possible to achieve a function of assigning an exclusively used memory space to each of the tasks and it is possible to maintain computer programs and data while avoiding interference among the tasks. However, there are tasks that share a memory space among the tasks. If multiple tasks share the memory space, the tasks share both the corresponding program and the data. However, the status of the CPU is not shared. Therefore, when such tasks are processed in parallel, the status of executing the corresponding program is almost the same as the status of cooperatively executing one computer program by the multiple CPU.

One of the various tasks is a “kernel task” which is a special task. The kernel task is the only task that conducts a task control, and the kernel task is the only one that is a resident task while the computer system is processing. While the kernel task is operating, the CPU can process special operations such as creating a new task, deleting a task and conducting an exception operation, and the CPU cannot process such operations while other tasks are operating. In addition, the CPU can read/write a memory space regardless of the tasks while the kernel task is operating. It should be noted that a task other than the kernel task is called a “user task” in order to distinguish the kernel task from the other tasks.

As described above, a task is suspended during processing if the CPU detects an “exception”. An “exception” is a “status which needs a special operation” detected by the CPU while executing a program. For example, such status includes “a divisor is 0 when calculating a division”, “a read/write protected area is detected when reading/writing the area of the memory”, “a signal which indicates a requirement of urgent reaction is input from an external device”, “a timer notifies a time for periodical task switching”, and the like.

In the multitasking computer system, when an exception is detected, the CPU immediately suspends an executing task, switches the executing task to the kernel task and executes an exception program. The exception program analyzes the exception and conducts a corresponding operation, for example, the exception program conducts an error operation, controls the external devices, and the like, and after that, an operation is switched to a task switching program. The task switching program selects one task that should be executed in accordance with the status of all tasks, and conducts a task switching to the selected task.

In a computer system that is not a multitasking computer system (single task computer system), when an exception is detected, the CPU immediately suspends an executing task and executes an exception program. However, after conducting an appropriate operation with regard to the exception by the exception program, such a computer system immediately resumes the suspended task.

In general, an operation that resumes the task which has been suspended due to an exception is called an “exception recovery operation”. Suspension of the task is always caused by the exception, and the task switching operation always resumes the task that has been suspended due to the exception. Therefore, it can be said that the task switching is a kind of exception recovery operation.

It should be noted that there are two types of exceptions. A first type as described above is an exception raised while the computer system is normally operating, such as, for example, “a signal is detected from an external device” and “a notification from a timer”. A second type as described above is an exception which is not considered to be a normal operation by a manufacturer of the computer system, such as, for example, “a divisor is 0” and “access to read/write protected area”. Here, the first type is called “exception in normal operation”, and the second type is called “exception in abnormal operation”.

The most difficult point in an operation using the debugger is to determine the “points of a computer program to be suspended” beforehand.

In general, the following steps are conducted in a debugging operation by using the debugger. First, an operator inputs a command to the debugger for forcibly suspending the CPU. The operator changes the instruction of a point of a computer program at which the operator is going to analyze, by replacing with the break instruction. When the CPU executes the break instruction, the debugger detects the execution of the break instruction and urges the operator to start the debugging operation. Therefore, the operator can analyze the changes and operations of the computer program and the like around the point at which the break instruction is set when the CPU processes that portion in detail.

However, in the most of cases, such a point to be analyzed in the computer program is not clear. Therefore, the operator should prepare various things and ideas before the debugging operation in order to find such a point to be analyzed.

Here, if the computer program raises an exception caused by an abnormal operation such as zero division, the point to be analyzed is clear because it is possible to obtain a clue for solving the problem by suspending the computer program at the point at which the exception has been raised and by analyzing status of the CPU, memory, and the like.

However, in many cases, it is very difficult to determine a point at which the computer program raises an exception because of an abnormal operation beforehand. In most of the cases, such an exception is raised at a point outside the operator's prediction. In other words, the operator may unfortunately miss the point at which the exception has been raised and the operator has not set the break instruction. Such a problem has great adverse effects especially if the problem rarely occurs.

With regard to such a problem, a conventional debugger activation program has, for example, the following methods for handling the problem (see Japanese Patent Application, First Publication No. H08-30485).
1. Overall memory space is set to be protected from writing beforehand.
2. If the CPU conducts a writing operation on the memory while a computer program is being executing, the CPU switches control to the exception program because a write error of the memory is detected.
3. The CPU determines whether or not a writing operation is appropriate while executing the exception program. If the writing operation is appropriate, the CPU actually writes the memory and recovers from the exception. However, if the writing operation is not appropriate, the CPU activates the debugger.

However, in accordance with the methods described above, the CPU activates the debugger while the exception program is running. Therefore, the program which has raised the exception is not executed by the CPU at the exact time the debugger suspends the CPU, so, the exception program of the kernel task is suspended. The status of the task is changed, and by applying the above-described conventional method, it is not possible to analyze the status of both the CPU and the memory at the exact time the exception is raised.

Therefore, there is still a problem in which it is not possible to analyze the status of the CPU, and the like at the exact time when the CPU raises the exception due to an abnormal operation.

The present invention has an objective to provide a method in which, even if the break instruction and the like is not set beforehand, the debugger can suspend the CPU when the exception has been raised due to an abnormal operation while maintaining status of the task, the CPU and the memory as it exactly was just before executing the instruction which has caused the exception.

### SUMMARY OF THE INVENTION

The present invention was conceived in order to solve the above-described problems, and has the following aspects.

A first aspect is an exception operation apparatus activated when an exception is raised in a computer, including: an analysis portion which analyzes the exception; and a rewriting portion which replaces a first instruction included in an area of a memory space that has raised the exception with a second instruction for activating a debugger.

A second aspect is an exception operation method of an exception operation apparatus which is activated when an exception is raised in a computer, including: a step of analyzing the exception; and a step of replacing a first instruction included in an area of a memory space that has raised the exception with a second instruction for activating a debugger.

A third aspect is an exception operation program stored on a computer readable medium that is activated when an exception is raised in a computer, including computer executable instructions for: analyzing the exception; and replacing a first instruction included in an area of a memory space that has raised the exception with a second instruction for activating a debugger.

A fourth aspect is an exception operation apparatus which activates a debugger that is activated by executing a debugger activation instruction, wherein the exception operation apparatus activates the debugger by executing another instruction in place to the debugger activation instruction when a trigger is detected that is an exception.

In the above-described aspects, a computer which executes a program to be debugged, analyzes an exception raised on the computer, and replaces an original instruction with another instruction for activating a debugger if the exception has been raised due to the instruction that conducts an abnormal operation and that is stored in a memory space. After this, the computer selects and switches to a task to be processed based on the status of each of the tasks, or resumes an operation which has been suspended due to the exception. Then, when the computer executes the instruction for activating the debugger, the debugger detects this execution and is activated.

In accordance with the above-described aspects, for instance, an instruction which has raised an exception due to an abnormal operation is replaced by another instruction for activating a debugger (such as a break instruction). Therefore, after this, if the task which has raised the exception is resumed because of an exception recovery operation, the debugger can suspend a CPU in a status just before raising the exception.

In addition, even if an exception is raised due to an abnormal operation of an instruction included in a computer program shared among multiple tasks of a multitasking computer system, it is possible to avoid from activating a debugger while processing tasks other than the task which has raised the exception.

The present invention has an advantage in that it provides a method in which the debugger can suspend the CPU when the exception has been raised due to an abnormal operation while maintaining the status of the task, the CPU and the memory as it was just before executing the instruction which caused the exception.

### BRIEF DESCRIPTION OF THE DRAWINGS

FIG. 1 is a block diagram of a multitasking computer system which is an example of implementing the present invention.

FIG. 2 is a flowchart of a multitasking computer system which is an example of implementing the present invention.

FIG. 3 is a drawing which shows the constitution of a task switching program.

FIG. 4 is a flowchart which shows the operation of a task switching program.

FIG. 5 is a flowchart of a multitasking computer system which is an example of an implementation of the present invention.

FIG. 6 is a block diagram of a single task computer system which is an example of an implementation of the present invention.

FIG. 7 is a flowchart of a single task computer system which is an example of an implementation of the present invention.

FIG. 8 is a block diagram of a television apparatus which is an example of an implementation of the present invention.

FIG. 9 is a block diagram of a cellular phone which is an example of an implementation of the present invention.

FIG. 10 is a drawing which shows an example of a screen displayed while a debugger is operating.

FIG. 11 is a drawing which shows an example of a screen displayed while a debugger is operating.

### DETAILED DESCRIPTION OF THE INVENTION

### [First Embodiment]

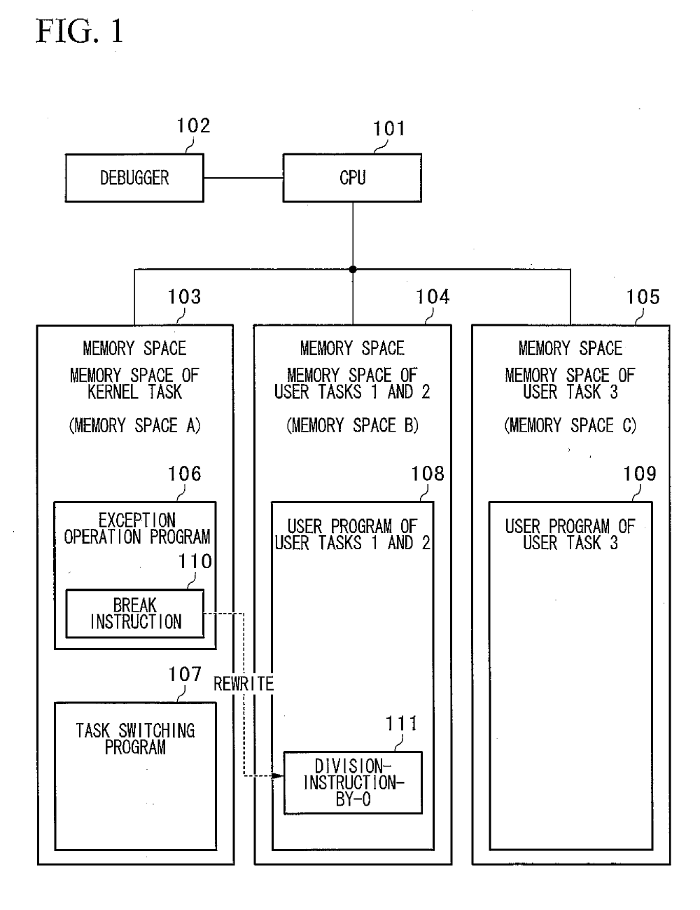

FIG. 1 is a block diagram of a multitasking computer system that shows a first embodiment of the present invention.

The multitasking system includes: a CPU 101; a debugger 102 which controls the status of the CPU 101 while the debugger 102 is activated, and supports a debugging operation of a computer program; a memory space 103 of a kernel task which is processed by the CPU 101; a memory space 104 of both a user task 1 and a user task 2 which are processed by the CPU 101; and a memory space 105 of a user task 3 which is processed by the CPU 101. Here, the status of the CPU 101 is, for example, a value stored in a register for calculation, a program counter, and the like.

The memory space 103 of the kernel task stores an exception program 106 and a task switching program 107. The memory space 104 of the user tasks 1 and 2 stores a user program 108 of the user tasks 1 and 2. The memory space 105 of the user task 3 stores a user program 109 of the user task 3.

In addition, the exception program 106 includes a break instruction 110, and the user program 108 of the user tasks 1 and 2 includes a division-instruction-by-0 111.

The CPU 101 controls the operation of the overall multitasking system of this embodiment. In addition, in the multitasking system of this embodiment, the CPU 101 controls four tasks that are the kernel task and user tasks 1-4 processed in parallel.

The debugger 102 supports a debugging operation of an operator, for example, by checking the internal status of the CPU 101 and controlling the CPU 101 so as to incrementally execute the instructions of computer programs.

The memory space of each of the tasks includes, for example, a computer program, data and the status of the CPU 101. In this example, the user tasks 1 and 2 share the memory space 104 and the computer program stored in the memory space 104.

The break instruction 110 is an instruction requesting the CPU 101 to activate the debugger 102. If the CPU 101 executes the break instruction 110, the debugger 102 detects the break instruction 110, immediately suspends the CPU 101 and urges the operator to start the debugging operation.

The division-instruction-by-0 111 is a division instruction to which 0 is accidentally set as a divisor, is generated because of a bug of the computer program, and is not in an originally expected status. In order to obtain a clue for a debugging operation, for the operator of the debugging operation, it is greatly important to suspend the CPU 101 in a status immediately just before the step of executing the division instruction. If the CPU 101 executes the division-instruction-by-0 111, an exception called “division by zero” is raised.

It should be noted that, regarding both of the user tasks 1 and 2, there is a possibility of executing the division-instruction-by-0 111 because both the tasks 1 and 2 share a program area. Here, for convenience of explanation, a case is explained in which the division instruction is executed while the user task 1 is processed.

The exception operation program 106 is a computer program which is executed when the CPU 101 detects an exception. When the CPU 101 detects an exception, the CPU 101 automatically suspends the task which is currently being processed, switches to the kernel task, starts executing the exception operation program of the kernel task, determines the type of the exception, and processes an appropriate operation in accordance with the type of the exception.

In addition, the exception operation program 106 provides a function that replaces or overwrites an instruction which has caused the exception with the break instruction 110 if the exception detected by the CPU 101 is an “exception due to an abnormal operation”.

The task switching program 107 is executed in order to determine a “task to be processed next” by the CPU 101. After executing the exception operation program 106, the CPU 101 executes the task switching program 107 in order to appropriately determine a task to be processed next based on information such as the history of processing the tasks and the priority among the tasks.

In other words, the task switching program 107 is a computer program which conducts a recovery operation to recover from the exception. It should be noted that in a following second embodiment, the above-described exception operation program 106 conducts a recovery operation from the exception.

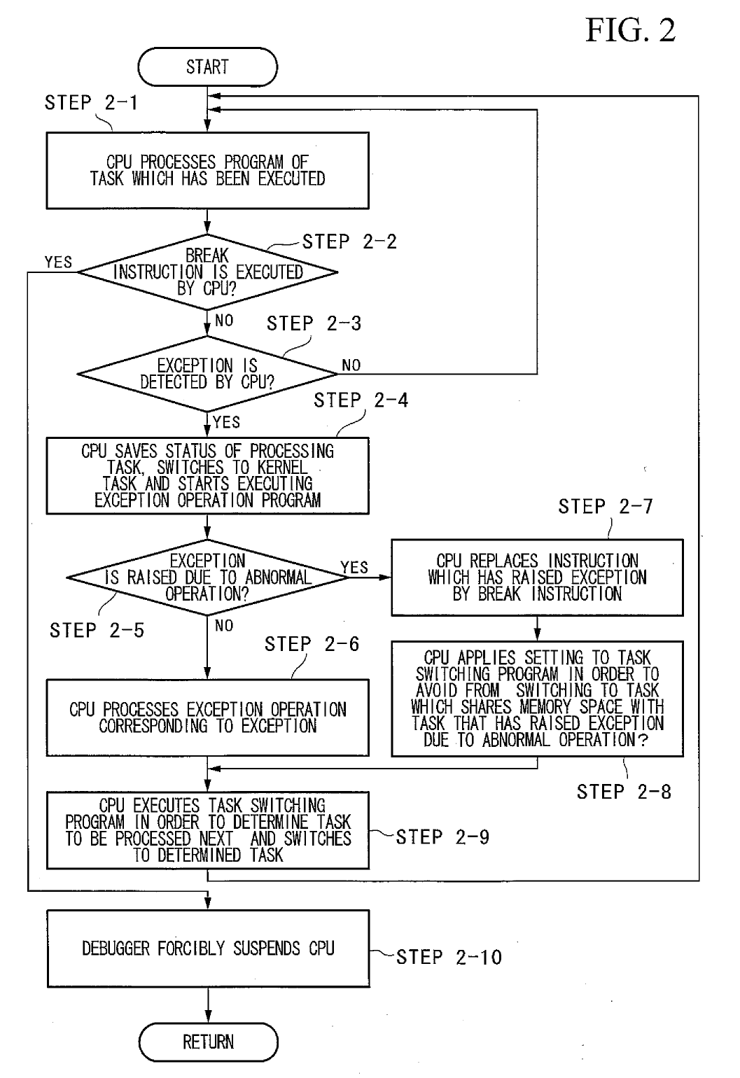

With reference to FIG. 2 which shows a flowchart, an operation of the multitasking system of this embodiment is explained.

First, in Step 2-1, the CPU 101 executes a program of a currently processing task. The next operation is Step 2-2.

In Step 2-2, the debugger 102 determines whether or not the CPU 101 has executed the break instruction. If the CPU 101 has executed the break instruction, the next operation is Step 2-10. If the CPU 101 has not executed the break instruction, the next operation is Step 2-3.

In Step 2-3, the CPU 101 determines whether or not the exception is detected. If the CPU has not detected the exception, the next operation is Step 2-1, and the CPU 101 keeps continuously executing the computer program. If the CPU has detected the exception, the next operation is Step 2-4.

In Step 2-4, after saving the status of the currently processing task, the CPU 101 switches to the kernel task and starts executing the exception operation program 106. The next operation is Step 2-5.

In Step 2-5, the CPU 101 executes the exception operation program 106 in order to analyze the exception. In other words, the CPU 101 executes a series of instructions for above-described analysis that are included in the exception operation program 106 which has been written into the memory space 103 of the kernel task, and consequently, the exception operation apparatus is constituted. If the exception is an “exception due to abnormal operation”, the next operation is Step 2-7. If the exception is not an “exception due to abnormal operation”, the next operation is Step 2-6.

If the “division-instruction-by-0” of the user task 1 has already been processed at Step 2-1, in Step 2-1, the CPU 101 determines that the next operation is Step 2-7.

In Step 2-6, the CPU 101 executes the exception program 106 in order to conduct an operation corresponding to “exception in normal operation” such as an operation corresponding to a signal from an external device requesting for an urgent reaction. The next operation is Step 2-9,

In Step 2-7, the CPU 101 replaces an instruction which has raised the exception due to an abnormal operation and which is included in the memory space of the user task that has raised the exception due to an abnormal operation. In other words, the CPU 101 executes a series of instructions with regard to the above-described replacing operation that are included in the exception operation program which has been written into the memory space 103 of the kernel task, and consequently, a portion of replacing operation of the exception operation apparatus is constituted. For example, if the “division-instruction-by-0 111” has been executed at Step 2-1, here at Step 2-7, the “division-instruction-by-0 111” is replaced by the “break instruction 110”. The next operation is Step 2-8.

In Step 2-8, the CPU 101 applies a setting to the task switching program 107 in order to avoid from switching to a “task which shares the memory space with the task that has raised the exception due to abnormal operation”. In other words, if the “division-instruction-by-0 111” of the user task 1 has been executed at Step 2-1, the CPU applies a setting to the task switching program 107 in order to avoid from switching to the user task 2 in the following operation. It should be noted that a reason why such an operation is conducted is explained below, and the task switching program 107 is explained below in detail. The next operation is Step 2-9.

At Step 2-9, the CPU 101 executes the task switching program 107 in order to appropriately determine the task to be processed next based on information such as the history of the processing of the tasks and priority among the tasks, and switches to the determined task. The next operation goes back to Step 2-1.

Here, it should be noted that if the “division-instruction-by-0 111” has been executed at Step 2-1, as described at Step 2-8, a task switching to the user task 2 is avoided.

In addition, if the user task 1 is selected here, an operation status of the CPU just before executing the instruction which has caused the “exception due to an abnormal operation” is recovered, and the next operation goes back to Step 2-1. In such a case, a next instruction to be executed is the break instruction which has been written at Step 2-7. Therefore, the next operation is Step 2-10, not Step 2-2.

Finally, at Step 2-10, the debugger 102 detects “execution of the break instruction by the CPU”, forcibly suspends the CPU 101, and urges the operator to start a debugging operation.

Therefore, the multitasking system of this embodiment can activate the debugger 102 when the exception has been raised due to an abnormal operation while maintaining the status of the task, the CPU, and the memory as it was just before executing the instruction which has caused the exception.

Here, a reason why an operation of Step 2-8 is conducted is explained. As described in this embodiment, if a program which includes an “instruction which causes an exception due to an abnormal operation” is shared among multiple programs, the above-described Step 2-8 has an important function. In more detail, if, for example, the user task 1 raises “exception due to a division by zero”, the computer program is modified at Step 2-7. In such a case, if the user task 1 in which the instruction is executed and that has raised the exception due to the abnormal operation is not selected, and the user task 2 which shares the computer program with user task 1 is selected at Step 2-9, the break instruction 110 is executed while the user task 2 is being processed. That is, the debugger 102 is activated even though it is not just before executing the instruction that raised the exception due to the abnormal operation, and consequently, there is a possibility of inappropriate operation being conducted by the operator.

In this embodiment, an operation of Step 2-8 is conducted. Therefore, for example, if a program which includes an “instruction which causes an exception due to an abnormal operation” is shared among multiple programs, it is possible to activate the debugger 102 in a condition in which the task that raised the “exception due to an abnormal operation” is being processed.

Here, the task switching program 107 used in the first embodiment is explained in detail.

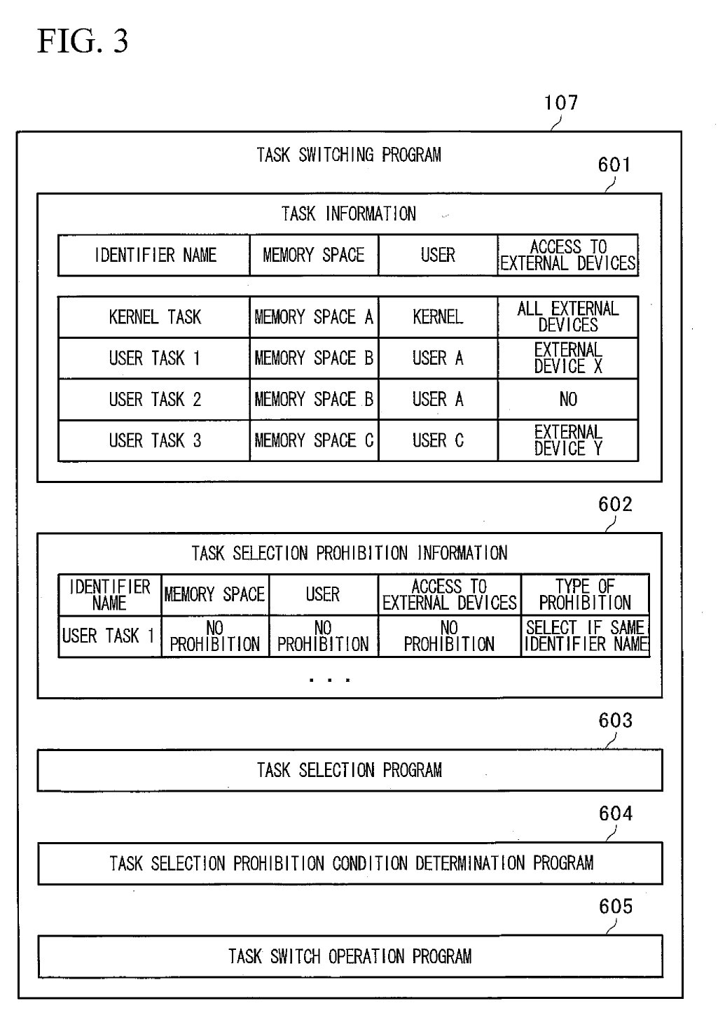

FIG. 3 is a block diagram which explains the “task switching program” 107 of the multitasking computer system of the first embodiment in detail.

As shown in FIG. 3, the task switching program 107 includes: task information 601 including information on each of all of the tasks generated by the multitasking computer system; task selection prohibition information 602 including information of “tasks that can be switched to and tasks that cannot be switched to”; a task selection program 603 which selects a task to be switched to based on the task information 601; a task selection prohibition condition determination program 604 which determines whether or not the selected task is a task that can be switched to based on the task selection prohibition information 602; and a task switch operation program 605 which switches to the selected task.

In addition, as shown in FIG. 3, the task information 601 includes: information of a memory space which is used by each of the tasks (kernel task and user tasks 1-3) (information for identifying memory spaces A-C); user information of a user who has activated a task (information for identifying kernel, user A and user B); and information indicating external devices that are used by a task (for example, currently opened files, identification information of the external devices stored in a memory space, and information on a memory-mapped I/O space that can be directly accessed by using a memory-mapping technique. FIG. 3 shows, for example, “external device X” or “no” as a convenient reference.

As shown in FIG. 3, the task selection prohibition information includes conditions for determining whether a task can be switched to or should not be switched to. In an example shown in FIG. 3, the stored condition indicates that “only the task that has an identifier name of “user task 1” is selected”. It should be noted that the kernel task is not indicated as a task to be switched to. However, in a multitasking computer system which provides memory spaces by applying virtual memory technique, it is necessary to operate a page fault exception, and the kernel task is a task to be switched to. In other words, in such a computer system which is applying virtual memory techniques, if a page including a portion of the user program 108 of the user task 1 that is about to be accessed by the CPU 101 has been paged out (corresponding area of the physical memory apparatus has been swapped and saved in an external storage apparatus beforehand), it is necessary to conduct a page-in operation (reading the corresponding page from the external storage device and writing the page into the memory apparatus).

It should be noted that such an operation of the task switching program 107 is a concrete example of an operation explained at Step 2-8 of FIG. 2 in the first embodiment. That is, “the CPU 101 applies a setting to the task switching program 107 in order to avoid from switching to a ‘task which shares the memory space with the task that has raised the exception due to abnormal operation’”. In other words, as a concrete example, it is possible to realize an operation of Step 2-8 by adding information to the task selection prohibition information.

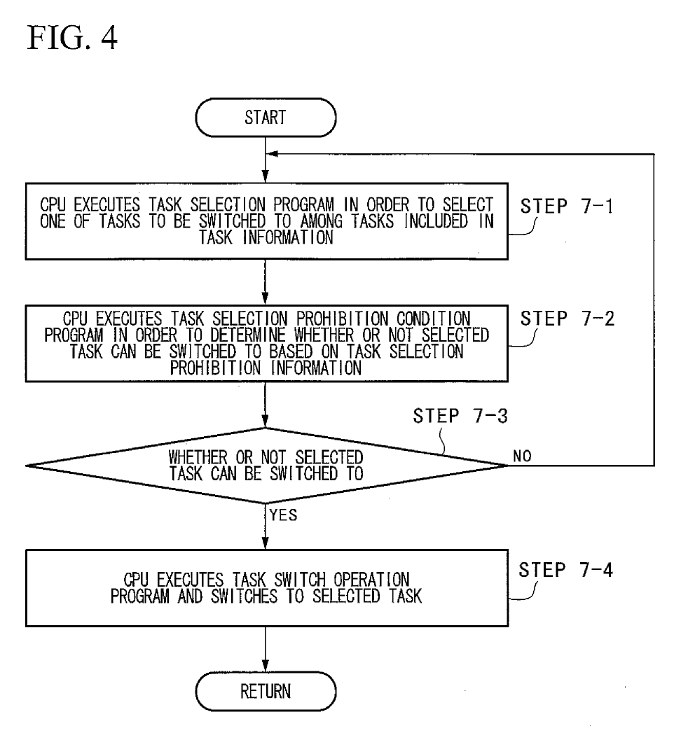

Hereinafter, in reference to a flowchart shown in FIG. 4, an operation of the task switching program 107 is explained.

First, in Step 7-1, the CPU 101 executes the task selection program 603 in order to select one of the tasks to be switched to among the tasks included in the task information 601. The next operation is Step 7-2.

In Step 7-2, the CPU 101 executes the task selection prohibition condition program 604 in order to determine whether or not the task selected at Step 7-1 just before Step 7-2 is a task which can be switched to. The next operation is Step 7-3.

In Step 7-3, the CPU 101 determines to conduct an operation of Step 7-4 if the selected task is a task which can be switched to, and determines to conduct an operation of Step 7-1 in an adverse case. Here, if the selected task is not a task which can be switched to, it is preferable to avoid from selecting the same task in the following operation of Step 7-1. Such a preferable operation can be conducted, for example, if the task selection program 603 uses an algorithm for selecting a task such as setting a lower score or priority to a frequently processed task in order to reduce the frequency of that task, before conducting an operation of 7-1 again, a lower score or priority is set to a task which has been selected at Step 7-1 and which has been detected as an inappropriate task for switching to.

At Step 7-4, the CPU 101 switches to the selected task. The operation of the task switching program 107 is finished.

With regard to an example of the task information 601 and the task selection prohibition information 602 shown in FIG. 3, operation of Steps from 7-1 to 7-3 of FIG. 4 are repeated until the user task 1 or the kernel task is selected at Step 7-1. If the user task 1 or the kernel task is selected at Step 7-1, the operation is finished.

In the above-described example, the task information 601 and the task selection prohibition information 602 include information such as the task ID, the memory space, the user who has activated the task and the external devices which the task accesses. However, it should be noted that this is not a limitation and the task information 601 and the task selection prohibition information 602 can include any type of information with regard to the task such as memory usage and the history of task switching.

### [Second Embodiment]

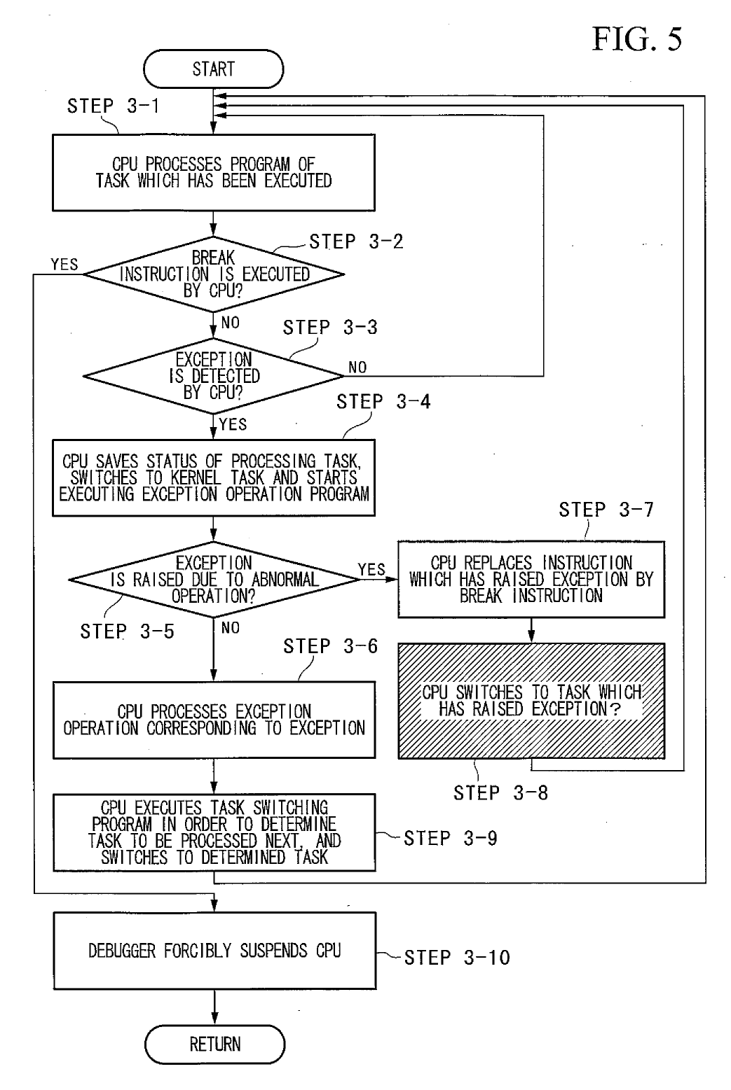

In reference to FIG. 5 which shows a flowchart, the operation of a multitasking system of another embodiment is explained.

It should be noted that only Step 3-8 of FIG. 5 is different from FIG. 2, and other steps of FIG. 5 are the same as FIG. 2. In other words, the same explanations of Steps from 2-1 to 2-7, 2-9 and 2-10 of FIG. 2 are respectively applied to Steps from 3-1 to 3-7, 3-9 and 3-10 of FIG. 5. Therefore, explanations with regard to Steps other than 3-8 are omitted. It should be noted that FIG. 5 does not include the operation of setting the “program to be switched” included in FIG. 2. Therefore, it is possible to apply a program which can conduct a generally used task switching operation to the task switching program 107 of the second embodiment.

In Step 3-8, the CPU 101 conducts an operation directly switching to a “task which has raised an exception due to an abnormal operation”. As a result, the CPU 101 can immediately recover the status of the “task which has raised an exception due to an abnormal operation” without executing the task switching program 107. In such a case, the next operation is Step 3-1, not Step 3-9.

If the “division-instruction-by-0 111” has already been executed at Step 3-1, an operation status of the CPU 101 just before executing the instruction which has caused the “exception due to an abnormal operation” is recovered, and the next operation goes back to Step 3-1. Here, a next instruction is the break instruction written at Step 3-7. Therefore, as a result of executing the instruction, the operation goes from Step 3-2 to Step 3-10, and the debugger 102 is activated.

As described above, even if an operation of “applying a setting to the task switching program in order to avoid from switching to a ‘task which shares the memory space with the task that has raised the exception due to abnormal operation’” as shown by Step 2-6 in FIG. 2 is not conducted, it is possible to obtain the same advantage as in the operation described in FIG. 2.

However, in such a case, the operation of recovering from the exception is conducted without regular operation of a computer system of recovering from the exception. Therefore, there is a possibility of causing inconsistency inside the computer system. Therefore, the operation of the first embodiment is possibly preferable for the operation introduced into a multitasking computer system rather than the second embodiment.

### [Third Embodiment]

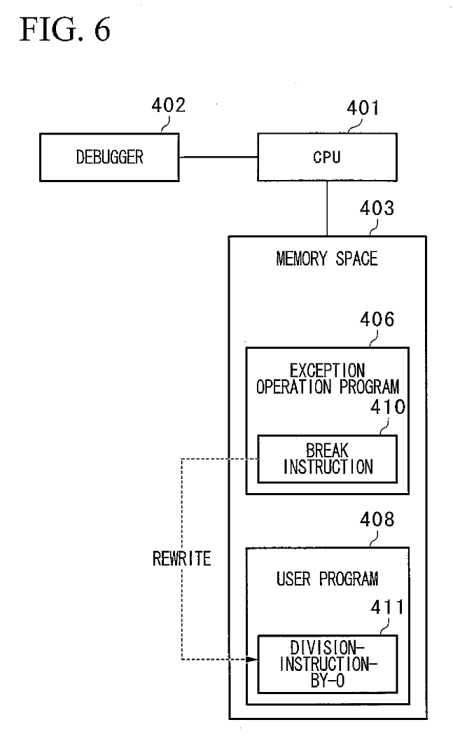

FIG. 6 shows a block diagram of a single computer system of a third embodiment of the present invention.

The single task system includes: a CPU 401; a debugger 402 which controls the status of the CPU 401 while the debugger 402 is activated and supports a debugging operation of a computer program; a memory space 403 managed by the CPU 401.

In addition, the memory space 403 stores an exception operation program 406 and a user program 408.

The exception operation program 406 includes a break instruction 410, and the user program 408 includes a division-instruction-by-0 411.

The CPU 401, the debugger 402, the memory space 403, the user program 408, the break instruction 410 and the division-instruction-by-0 411 are the same as the above-described first embodiment, explanations of these items are omitted.

The exception operation program 406 is almost the same as the first embodiment, but after conducting the exception operation, the CPU 401 immediately conducts an exception recovery operation in place of executing the task switching program.

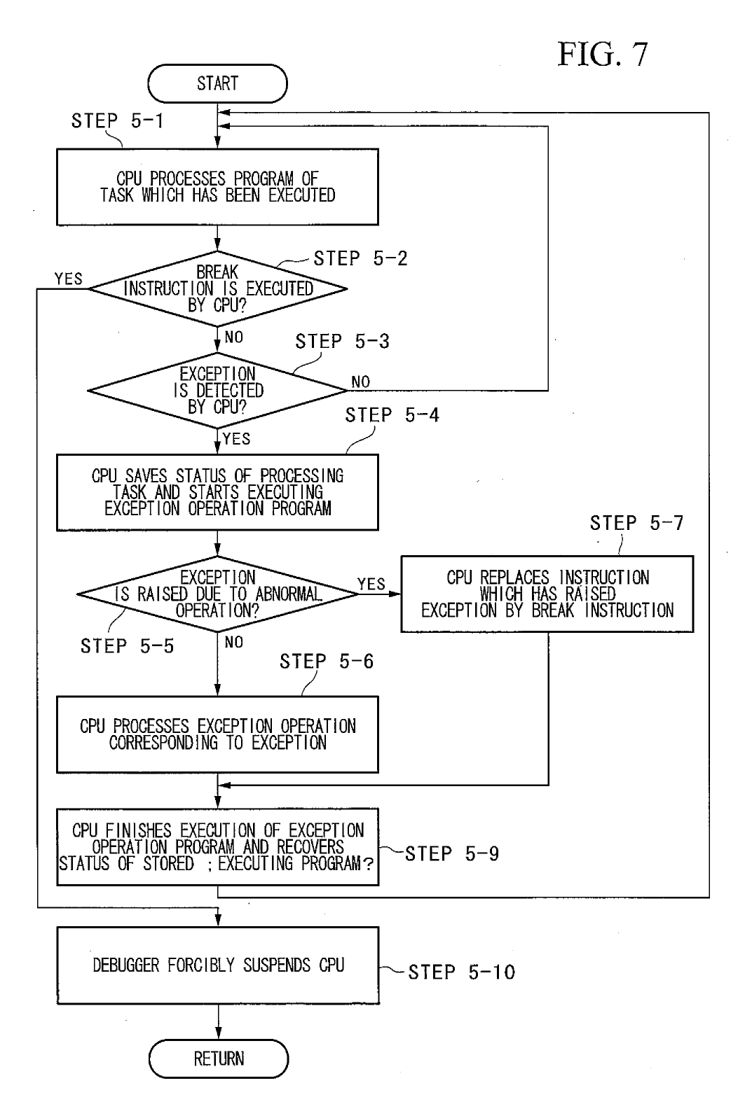

An operation of the single task system is explained in reference to a flowchart of FIG. 7.

First, in Step 5-1, the CPU 401 executes a computer program. The next operation is Step 5-2. Steps 5-2 and 5-3 are the same as the above-described Steps 2-2 and 2-3.

In Step 5-4, after saving the status of the currently processing task, the CPU 401 starts executing the exception operation program 406. The next operation is Step 5-5. Steps from 5-5 to 5-7 are the same as the above-described Steps from 2-5 to 2-7.

At Step 5-9, the CPU 401 processes an exception recovery operation. The next operation is Step 5-1. Step from 5-10 is the same as the above-described Step 2-10.

If the “division-instruction-by-0 411” of the user program 408 is executed, as described in the first embodiment, operations of Steps 5-3, 5-4, 5-5 and 5-7 are processed, and after the division-instruction-by-0 411 is replaced by the break instruction 410, the CPU 401 processes an exception recovery operation. As a result, the processing status of the CPU 401 is recovered so as to be just before executing the division-instruction-by-0 411, and the next operation goes back to Step 5-1. At Step 5-1, the break instruction which has been just replaced at Step 507 is executed. Therefore, the operations of Steps 5-2 and 5-10 are processed, and consequently, the debugger 402 is activated.

Therefore, the single task system of this embodiment can activate the debugger 402 when the exception has been raised due to an abnormal operation while maintaining the status of the task, the CPU, and the memory as it was just before executing the instruction which has caused an exception.

It should be noted that the “task switching program” is not included in the single task system. Therefore, as described above, a generally used constitution for an exception recovery operation as described in the second embodiment is applied to the single task system in place of the constitution described in the first embodiment above.

In the above-described first to third embodiments, “division-instruction-by-0” causes an “exception due to an abnormal operation”. However, this is not a limitation, and there can be various instructions that cause an “exception due to an abnormal operation” such as “access to prohibited memory area”, “invalid address alignment” and “executing unknown instruction”.

In the first and second embodiments, a computer program including an “instruction that raises an exception due to an abnormal operation” is shared between the user task 1 and 2. However, it should be noted that this is not a limitation, and such a program can be shared by only one task. On the other hand, such a computer program can be shared among three or more tasks. Likewise, the number of user tasks is not limited to three.

In the first to third embodiments, the debugger is activated by executing a “break instruction”. However, this is not a limitation, and it is possible to apply any other instructions if the instruction can activate the debugger.

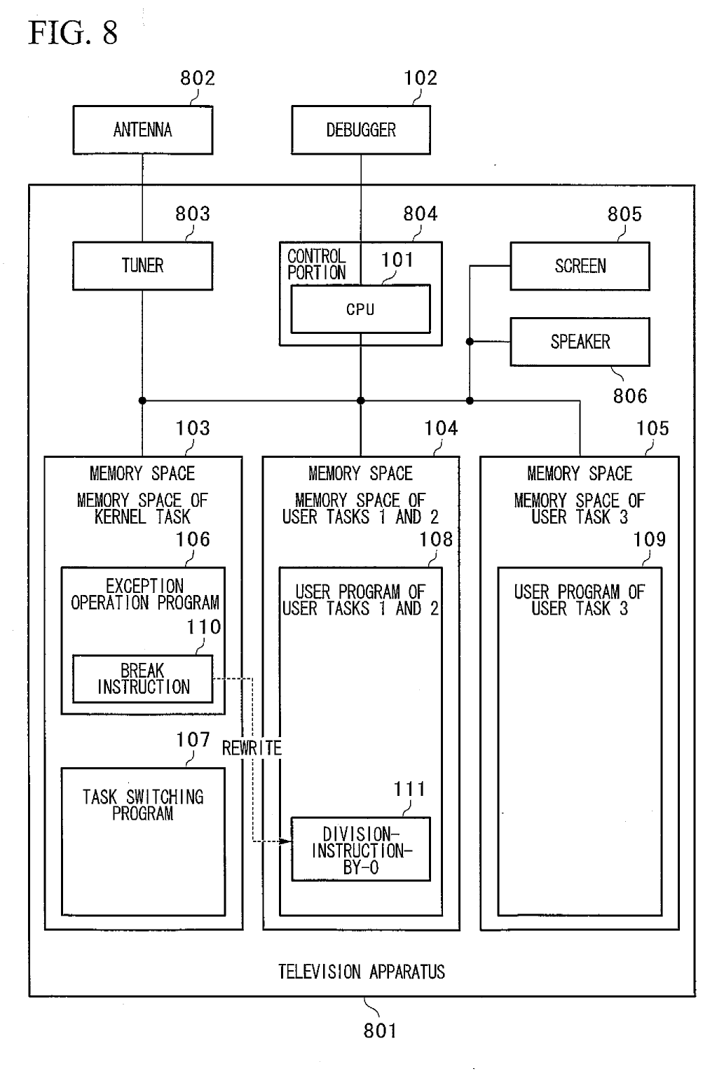

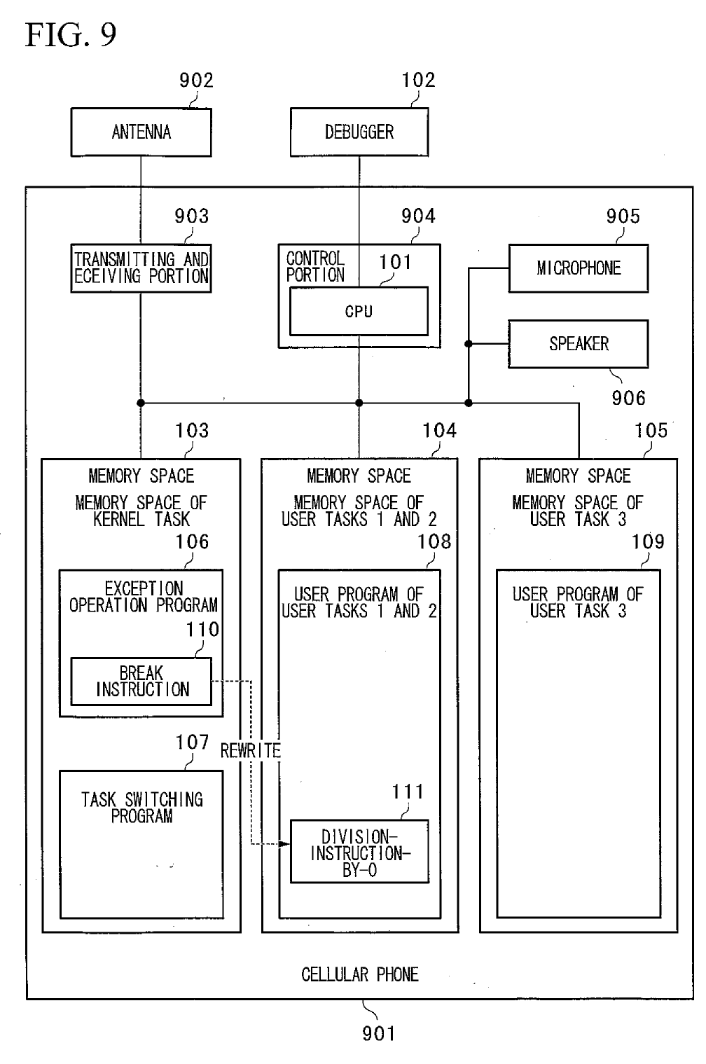

In reference to FIG. 8 and FIG. 9, an apparatus which is an example of an implementation of the present invention is explained. It should be noted that a television apparatus and a cellular phone described below are examples and are not limitations for implementing the present invention.

FIG. 8 is a block diagram of a television apparatus which is an example of an implementation of the present invention. A television apparatus 801 includes a tuner 803 connected to an antenna 802, a control portion 804, a screen 805, a speaker 806 and memory spaces 103, 104 and 105. It should be noted that a case of receiving the broadcasted waves via a cable (such as a coaxial cable and an optical cable) is not shown in the drawings, but in such a case, the tuner 803 is connected to the cable. In addition, the control portion 804 includes a CPU 101, and the CPU 101 is connected to a debugger 102 and is connected to the memory spaces 103, 104 and 105. As shown in FIG. 8, in the television apparatus 801, the tuner 803, the control portion 804, the screen 805, the speaker 806 and the memory spaces 103, 104 and 105 are connected to each other.

A constitution and an operation of the CPU 101, the debugger 102 and the memory spaces 103, 104 and 105 of FIG. 8 are described above in reference to FIG. 1 and FIG. 2. The television apparatus 801 shown in FIG. 8 includes the multitasking computer system as described above in reference to FIGS. 1 and 2.

The CPU 101 of the control portion 804 manages an operation of each of portions of the television apparats 801 by executing the computer programs stored in the memory spaces 103, 104 and 105. In other words, under control of the control portion 804, the tuner 803 plays images and sounds based on the received electric waves via the antenna 802 and outputs the images and sounds to the screen 805 and the speaker 806. The control operation of the control portion 804 includes the operation of the first embodiment explained in reference to FIG. 2. For example, if an operator connects the debugger to the CPU 101 of the television apparatus 801 and activates the television apparatus 801, the CPU 101 executes computer programs of the memory spaces 103, 104 and 105. After this, if the CPU 101 detects an exception due to an abnormal operation, an instruction which has raised the exception and is included in a memory space that has raised the exception is replaced by a break instruction, the debugger 102 detects the break instruction executed by that the CPU 101, the debugger 102 forcibly suspends processing of the CPU 101, and the debugger 102 urges the operator to start a debugging operation.

It should be noted that a constitution of the above-described television apparatus 801 is an example, and such a constitution is not a limitation for the present invention. In addition, the control portion 804 can conduct an operation described in the above-described second embodiment in reference to FIG. 5.

FIG. 90 is a block diagram of a cellular phone which is an example of implementing the present invention. A cellular phone 901 includes a transmitting and receiving portion 903 connected to an antenna 902, a control portion 904, a microphone 905, a speaker 906 and memory spaces 103, 104 and 105. In addition, the control portion 904 includes a CPU 101, and the CPU 101 is connected to a debugger 102 and is connected to the memory spaces 103, 104 and 105. As shown in FIG. 9, in the cellular phone 901, the transmitting and receiving portion 903, the control portion 904, the microphone 905, the speaker 906 and the memory spaces 103, 104 and 105 are connected each other.

A constitution and an operation of the CPU 101, the debugger 102 and the memory spaces 103, 104 and 105 of FIG. 9 are as described above in reference to FIG. 1 and FIG. 2. The cellular phone 901 shown in FIG. 9 includes the multitasking computer system as described above in reference to FIGS. 1 and 2.

The CPU 101 of the control portion 904 manages an operation of each of portions of the cellular phone 901 by executing computer programs stored in the memory spaces 103, 104 and 105. In other words, under a control of the control portion 904, the transmitting and receiving portion 903 demodulates a carrier wave received via the antenna 902 and outputs obtained sounds from the speaker 906, and the transmitting and receiving portion 903 modulates the carrier wave based on a input voice via the microphone 905 and transmits the modulated carrier wave via the antenna 902. The control operation of the control portion 904 includes the operation of the first embodiment explained in reference to FIG. 2. For example, if an operator connects the debugger to the CPU 101 of the cellular phone 901 and activates the cellular phone 901, the CPU 101 executes computer programs of the memory spaces 103, 104 and 105. After this, if the CPU 101 detects an exception due to an abnormal operation, an instruction which has raised the exception and is included in a memory space that has raised the exception is replaced by a break instruction, the debugger 102 detects the break instruction executed by that the CPU 101, the debugger 102 forcibly suspends the processing of the CPU 101, and the debugger 102 urges the operator to start a debugging operation.

It should be noted that a constitution of the above-described cellular phone 901 is an example, and such a constitution is not a limitation for the present invention. In addition, the control portion 904 can conduct an operation as described in the above-described second embodiment in reference to FIG. 5.

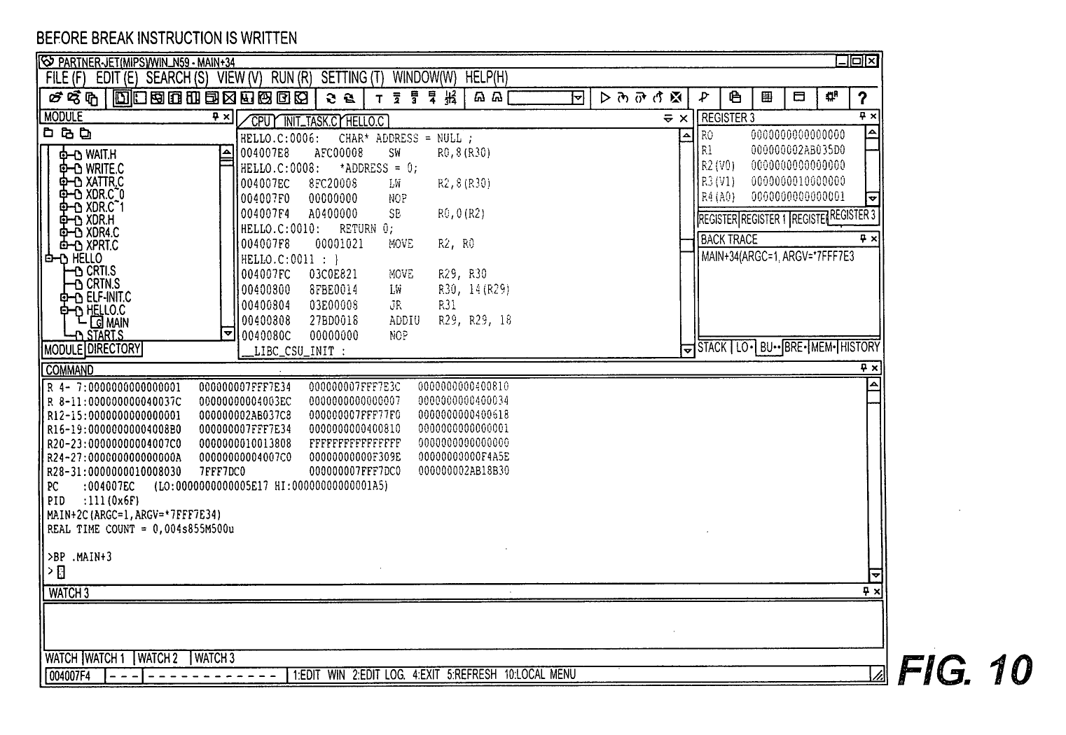

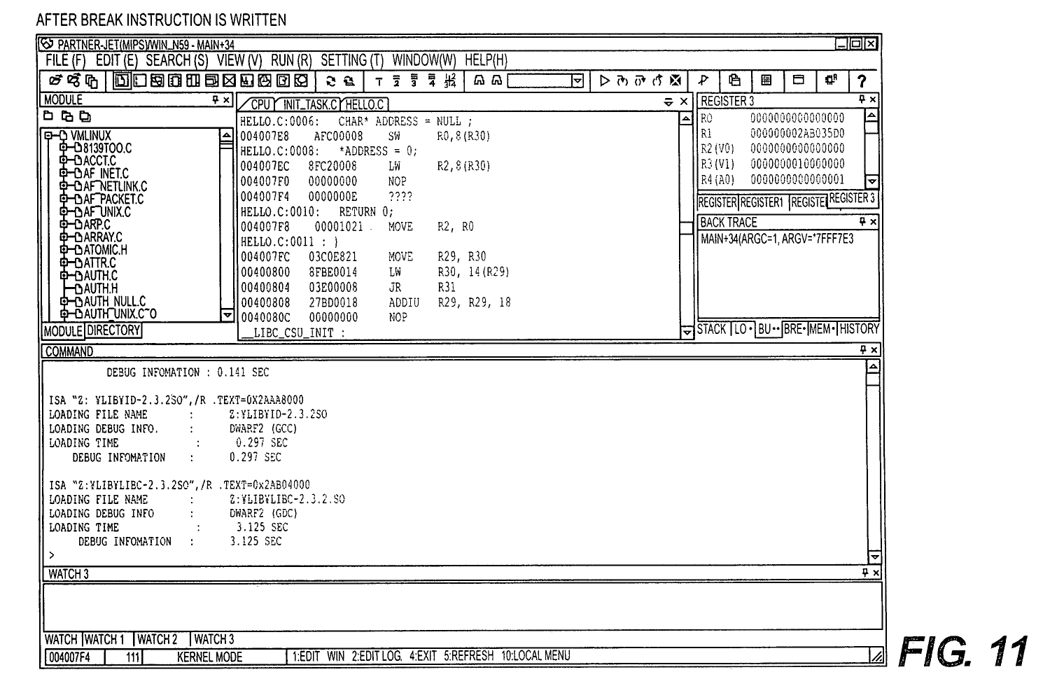

FIGS. 10 and 11 show concrete examples of screens while the debugger is activated. As described above, by using a probe, the debugger is connected to a CPU of a computer on which a computer program to be debugged is executed. In addition, the debugger is connected to a generally used personal computer via a communication interface, and a debugger control program executed on the personal computer shows the screens.

FIG. 10 shows a screen which is shown before writing the break instruction, and such a screen is shown when the operator operates the debugger in order to display the status of both the CPU and the memory before the processing Step 2-7 of FIG. 2. In FIG. 10, with regard to each of the lines on the left side of a center window on an upper portion of the screen, shows a memory address, a machine language code stored at the address and an assembler code corresponding to the address, and includes a corresponding source code. Here, for example, a line of “004007F4 A0400000 SB r0,0(r2)” shows an address where an instruction is stored and which accesses an invalid memory, a corresponding code of the machine language and an assembler code.

On the other hand, FIG. 11 shows a screen after writing the break instruction, and shows the status of the CPU and the memory at Step 2-10 of FIG. 2.

In a center window shown on an upper portion of the screen of FIG. 11, the instruction “A0400000” shown in FIG. 10 which was stored in the four-byte area at a memory address “004007F4” is replaced by the break instruction.

It should be noted that the above-described embodiments are examples of the present invention, and it is possible to apply the present invention to PHS (personal handy-phone system), PDA (personal digital assistant), a watch/clock, a personal computer, a car navigation system, and the like. In addition, it is possible to apply the present invention to home appliances other than television apparatuses.

It should be noted that it is possible to apply the present invention to a computer which includes multiple CPUs and to a computer which includes a multiple-core CPU.

It should be noted that the present invention can be applied to a debugging operation of a kernel.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An exception operation apparatus activated when an exception is raised in a computer, comprising:
an analysis portion which analyzes the exception; and
a replacing portion which replaces a first instruction included in an area of a memory space that has raised the exception with a second instruction for activating a debugger.

2. An exception operation method of an exception operation apparatus which is activated when an exception is raised in a computer, comprising:
a step of analyzing the exception; and
a step of replacing a first instruction included in an area of a memory space that has raised the exception with a second instruction for activating a debugger.

3. An exception operation program stored on a computer readable medium that is activated when an exception is raised in a computer, comprising computer executable instructions for:
analyzing the exception; and
replacing a first instruction included in an area of a memory space that has raised the exception with a second instruction for activating a debugger.

4. An exception operation apparatus which activates a debugger that is activated by executing a debugger activation instruction, wherein
the exception operation apparatus activates the debugger by executing another instruction in place to the debugger activation instruction when a trigger is detected that is an exception.

5 . A television apparatus comprising an exception operation apparatus which is activated when an exception is raised in a computer, wherein
the exception operation apparatus comprises:
an analysis portion which analyzes the exception; and
a replacing portion which replaces a first instruction included in an area of a memory space that has raised the exception with a second instruction for activating a debugger.

6. A television apparatus comprising an exception operation apparatus which activates a debugger that is activated by executing a debugger activation instruction, wherein
the exception operation apparatus activates the debugger by executing another instruction in place of the debugger activation instruction when a trigger is detected that is an exception.

7. A cellular phone comprising an exception operation apparatus which is activated when an exception is raised in a computer, wherein
the exception operation apparatus comprises:
an analysis portion which analyzes the exception; and
a replacing portion which replaces a first instruction included in an area of a memory space that has raised the exception with a second instruction for activating a debugger.

8. A cellular phone comprising an exception operation apparatus which activates a debugger that is activated by executing a debugger activation instruction, wherein
the exception operation apparatus activates the debugger by executing another instruction in place to the debugger activation instruction when a trigger is detected that is an exception.

9. An exception operation method conducting an exception operation when an exception is raised in a computer which conducts a multitasking operation, comprising steps of:
analyzing the exception;
replacing an instruction which has raised the exception with a debugger activation instruction by executing an exception operation program if the exception is raised due to an abnormal operation;
setting a task switching program to prevent switching to a task which shares a memory space with another task that has raised the exception;
executing a program of a currently processing task by the computer; and
suspending operation of a central processing unit of the computer upon execution of the debugger activation instruction by the computer.

10. An exception operation methods conducting an exception operation when an exception is raised in a computer which conducts a multitasking operation, comprising steps of:
analyzing the exception;
replacing an instruction which has raised the exception with a debugger activation instruction by executing an exception operation program if the exception is raised due to an abnormal operation;
switching to a task that has raised the exception;
executing a program of a task currently being processed by the computer; and
suspending operation of a central processing unit of the computer upon execution of the debugger activation instruction by the computer.

11. An exception operation method conducting an exception operation when an exception is raised in a computer which conducts a single task operation, comprising steps of:
analyzing the exception;
replacing an instruction which has raised the exception with a debugger activation instruction by executing an exception operation program if the exception is raised due to an abnormal operation;
terminating an exception operation program;
recovering stored status of an executing computer program executing the computer program of the processing task; and
suspending a central processing unit of the computer when the computer executes the debugger activation instruction.
